(19) United States
(12) Patent Application Publication
(10) Pub. No.: US 2010/0003927 A1
(43) Pub. Date: Jan. 7, 2010

(54) APPARATUS AND METHOD FOR POWER-SAVING AND WAKE-UP

(75) Inventors: Yu-Pin CHOU, Tongxiao Township (TW); Tzuo-Bo LIN, Taipei City (TW); Chih-Ming LEE, Xinzhuang City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: REALTEK SEMICONDUCTOR CORP., Hsinchu City (TW)

(21) Appl. No.: 12/496,237

(22) Filed: Jul. 1, 2009

Related U.S. Application Data
(63) Continuation-in-part of application No. 11/259,541, filed on Oct. 25, 2005.

(30) Foreign Application Priority Data
Oct. 29, 2004 (TW) 093133066

(51) Int. Cl. H04B 1/00

(52) U.S. Cl. 455/68

(57) ABSTRACT

Disclosed is an apparatus and method of power-saving and wake-up, which is not only used to reduce the power consumption of a system of electronic equipment, but also allow the system to immediately return to normal operation according to the requirement. The apparatus for power-saving and wake-up includes a first detector, a second detector, a decoder and a third detector. The method for power-saving and wake-up includes detecting a cable signal, a clock pair signal and a differential pair signal. When one of the detected signals is unusual, the system soon turns off the unusual channel power and implement the procedures for power saving and operates under the power saving mode, which can realize the effect of power saving and low power consumption. The method for power-saving and wake-up includes detecting the cable signal, the toggling and frequency of the clock signal and the synchronizing signals of the system.

### CROSS REFERENCE TO RELATED APPLICATIONS

The present invention is a CIP application of the parent application Ser. No. 11/259,541, filed on Oct. 25, 2005. “Method for Power Management In A Displays” which is hereby incorporated herein in its entirety by reference.

### FIELD OF TE INVENTION

The present invention relates to the field of power management, particularly to the apparatus and method for power-saving and wake-up of a receiver.

### BACKGROUND OF THE INVENTION

If a display device (for examples: CRT display or LCD display) has a power management function, the power consumption of the display device can be reduced and the components of the display device can be protected. The display power management signaling (DPMS) is a common standard for the display device. In the DPMS standard, the computer will selectively provide at least one of video signals (for example: a vertical synchronization signal, VSYNC, and a horizontal synchronization signal, HSYNC) to the display device, and the display device will determine to perform the power management function when the computer transfer no video signal to the display device. Generally speaking, both the computer and the display device have two operation modes (i.e., a normal mode and a power-saving mode). When the computer operates in the normal mode, the computer will transfer the video signal into the display device through a plurality of video charnels of a video interface, and the display device will display the video signal in the normal mode. When the computer enters the power-saving mode (for example: a user doesn't use this computer for a predetermined time interval), the computer will not provide the video signal to the display device and the display device will simultaneously enter the power-saving mode.

In prior technology, there are two conventional methods for power management of the display device. The first conventional method: the display device will turn off its power supply when it enters the power-saving mode. That is, the conventional display device disables (i.e. turns off) all video channels in the power-saving mode. The second conventional method: the display device will keep enabling (i.e. turning on) one of the video channels of the video interface and disabling other video channels in the power-saving mode. Generally speaking, the conventional display device will only keep enabling a blue channel when operating in the power-saving mode. The conventional display device will detect whether the video signal is input to the display device through the enabled video channel. When the video signal of the enabled video channel is detected, other disabled video channels will be enabled and the conventional display device will return to the normal mode. In the second conventional method, although the display device can respond to external changes in the power-saving mode, the enabled video channel needs to be kept enabled all the time and the power consumption of the display device can not be fully reduced.

Please refer to FIG. 1, which is a schematic diagram showing a conventional signal receiving equipment. The signal receiving equipment has a transmitter 11, a receiver 12 and a signal transmission line 13. The transmitter 11 also has a current source 111 and a pair of switches D and D′. Coupled to a power supply AVcc, the receiver 12 also has a receiver circuit (i.e. differential amplifier) and a pair of resistors RT and RT′. The resistors RT and RT′ respectively connect to the transmission line 13.

In this conventional structure, if the receiver 12 enters into the power-saving mode (the differential amplifier is disabled), the power supply AVcc of the receiver 12 will still flow through the pair of resistors RT and RT′ and the transmission line 13 and reach the grounding of the transmitter 11; in other words, even if the receiver 12 has entered the power-saving mode, the entire equipment will always provide current to the transmission line 13. The receiver 12 still consumes the power even though the system operates in the power-saving mode.

To solve the above drawbacks in the prior art, the applicant uses a detection function to turn off the partial circuit of the receiver for reducing the power consumption. The applicant also utilizes a detected signal generated from a detection circuit to activate the receiver to operate in the normal function. Therefore, the present invention “apparatus and method for power-saving and wake-up” is to overcome the above-mentioned shortcomings of conventional means.

In order to eliminate the drawbacks of the conventional techniques, the new concepts and the solutions are proposed in the present invention so as to solve the above-mentioned problems. The present invention is described below.

### SUMMARY OF THE INVENTION

The purpose of the present invention is to provide an apparatus and method for power-saving and wake-up to reduce the power consumption of a signal receiving device. Besides, the present can instantly activate a circuit by monitoring signals to satisfy the requirement of the user.

In accordance with one aspect of the present invention, a method used in a power-saving mode of a receiver, comprising the steps of: (a) detecting whether a first signal is normal in the power-saving mode and maintaining in the power-saving mode when the first signal is abnormal; and (b) detecting whether a second signal is normal when the first signal is normal in the power-saving mode, and maintaining the receiver in the power-saving mode when the second signal is abnormal.

Preferably, the receiver further comprises a first and a second channels and a power supply, and each of the steps (a) and (b) further comprises the steps of: detecting at least one signal from one of the first and the second channels and producing a control signal according to a detected result; and deciding whether to disconnect a connection between the power supply and at least one of the first and second channels according to the control signal so as to avoid a current flowing through the at least one of the first and second channels.

Preferably, the steps (a) and (b) are respectively performed by a step (a1) of activating a detecting function of the first channel and a step (b1) of activating a detecting function of the second channel.

Preferably, the receiver maintains in the power-saving mode when the first signal is abnormal.

Preferably, the first and the second channels respectively transmit a clock signal and a data signal.

Preferably, the first signal is one of a cable signal and a clock signal, and the second signal is one of the clock signal and a data signal.

Preferably, the receiver operates in a normal mode if the second signal is normal.

Preferably, the receiver has a third channel, and the method further comprises the steps of: detecting whether a third signal from the third channel is normal in the power-saving mode when the second signal is normal, wherein the receiver maintains the power-saving mode when the third signal is abnormal; and operating the receiver in the normal mode when the third signal is normal.

In accordance with another aspect of the present invention, A receiver is provided, comprising: at least one of receiving units, coupled to at least one of channels, respectively, receiving an input signal from the at least one of the channels; a control circuit detecting a specific one of the input signal from the at least one of the channels, producing a control signal according to a result of the detection, and having plural routes, each of which corresponds to the specific one of the input signal.

Preferably, the receiver further comprises at least one channel having the specific one of the input signal, a power supply, a receiver circuit receiving the specific one of the input signal from the at least one channel and having a control switch configured between the power supply and the at least one channel and deciding whether to disconnect a connection between the power supply and the at least one channel according to the control signal, and a following circuit receiving and processing an output signal from the receiver circuit.

Preferably, the receiver further comprises at least one of a digital visual interface and a high definition multimedia interface.

Preferably, the at least one channel has a first and a second channels respectively transmitting a clock signal and a data signal.

Preferably, the data signal is any one of three pairs of red, green and blue data signals.

Preferably, the at least one channel is used to transmit a clock signal, and the control circuit comprises a detector detecting at least one of toggling and frequency of the clock signal.

Preferably, the at least one channel is used to transmit a data signal, and the control circuit comprises a decoder decoding a data signal from the at least one channel and a first detector detecting the decoded data signal.

In accordance with another aspect of the present invention, a method used in a signal receiving device is provided. The method for a receiver coupling to at least one channel and having a power supply, comprising the steps of: detecting a specific one signal from the at least one channel and generating a control signal accordingly; and deciding whether to disconnect a connection between the power supply and the at least one channel according to the control signal so as to avoid a current flowing through the at least one channel when the receiver operates in a power-saving mode.

Preferably, the at least one channel comprises a first channel and a second channel having plural decoded data signals, and the method further comprises: detecting at least one of toggling and frequency of the clock signal of the first channel; detecting a specific one of the plural decoded data signals; and wherein the receiver turns off the first and the second channels when the detected specific decoded data signal is abnormal, and operates in a power-saving mode.

Preferably the plural decoded data signals comprise a horizontal synchronization signal, a vertical synchronization signal and a data enable signal.

Preferably, the at least one channel comprises a first and a second channels, the receiver further comprises a control switch deciding whether to disconnect a connection between the power supply and at least one of the first channel and the second channel according to the control signal, and the first channel and the second channel respectively transmit a clock signal and a data signal.

In sum, the present invention not only realizes the reduction of power consumption, but also improves the implementation of power-saving and wake-up for a signal receiving device.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing a conventional signal receiving equipment.

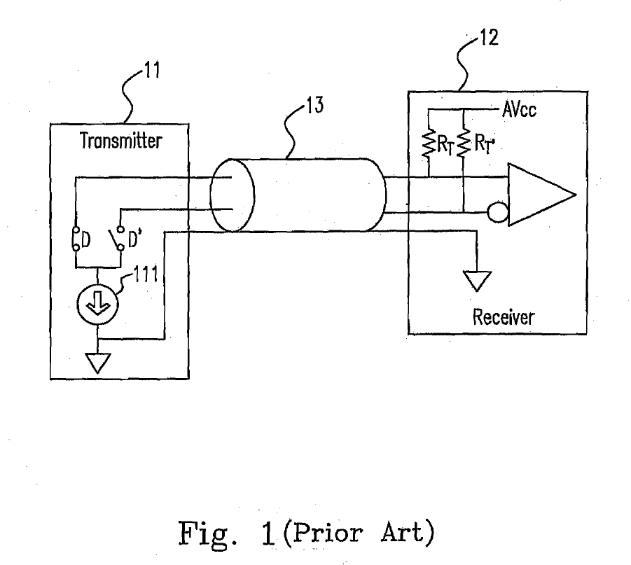

FIG. 2 is a simplified block diagram showing an apparatus for power-saving and wake-up of a signal receiving device of the present invention.

FIG. 3 (a) is the block diagram showing an apparatus for power-saving and wake-up of a clock channel of the present invention.

FIG. 3 (b) is the block diagram showing an apparatus for power-saving and wake-up of a data channel of the present invention.

FIG. 4 illustrates a flow chart the method for power-saving and wake-up in a signal receiving device according to an embodiment of the present invention.

FIG. 5 illustrates a flow chart the method for power-saving and wake-up in a signal receiving device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

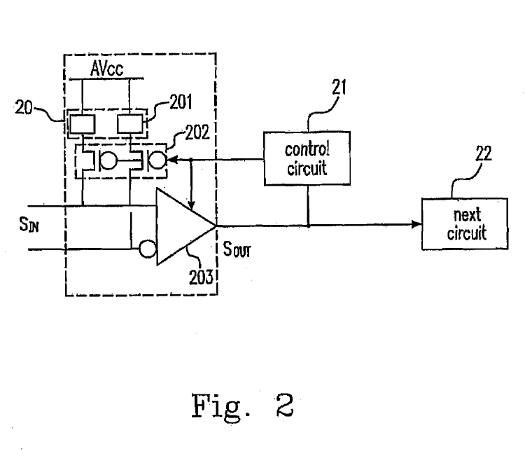

Please refer to FIG. 2, which is a simplified block diagram showing an apparatus for power-saving and wake-up of a signal receiving device of the present invention. The signal receiving device coupled to a power supply AVcc includes a receiver 20, a control circuit 21 and a next circuit 22. The receiver 20 further includes a pair of resistors 201, a pair of switches 202 and a differential amplifier 203. The receiver 20 receives an input signal S_{IN} from the transmitter 11. Then, the input signal S_{IN} is processing by the differential amplifier 203 and becomes an output signal S_{OUT}. The next circuit 22 receives the output signal S_{OUT} for the following treatment. At the same time, the control circuit 21 also receives the output signal S_{OUT}, detects whether the output signal S_{OUT} is normal or not and thereby outputs a detected signal. When the detected signal presents that the output signal S_{OUT} is abnormal, the control circuit 21 outputs a control signal (to enable/disable the other circuits), triggering the pair of switches 202 off (open). Thus, the power AVcc of the receiver 20 is unable to follow through the pair of resistors RT and RT′ and the transmission line 13 and be lead to the grounding of the transmitter 11. In other words, the current of the signal receiving device will not flow into the transmission line 13, which allows the receiver of the related channel no longer consuming the power (that is, entering into the power-saving mode). One skilled in the art should easily know that the pair of the switches 202 and the amplifier 203 can simultaneously be controlled by control signals, or respectively controlled by other circuits. In a power-saving mode, the present invention will activate a detection function after each predetermined interval (adjustable). In an embodiment of activating the detection function is that the control circuit 21 simultaneously controls the pair of switches 202 to be a conduction state (ON) and controls the control amplifier 24 to be an enabling state, and detects whether the input signal S_{IN} is normal or not, so as to decide whether the other circuit (e.g. the next circuit) of the related channel or/and other channels in other circuits activates a detection function or enters into a normal operating mode.

In another embodiment, the pair of resistors 201 and the pair of switches 202 can be implemented by a pair of transistors. In a normal mode and a detection function being activated, the gate voltage of the transistors can be controlled to provide impedance. In a power-saving mode, the pair of transistors is implemented as a pair of switches. Therefore, the power supply AVcc of the receiver 20 is not connected to the transmission line 13. Moreover, owing to the type or character of the input signal S_{IN} changed based on different interface standards, the implementing configuration of the control circuit 21 of the present invention will be changed to different forms according to the different types or formats of the input signal S_{IN}. In this specification, only a clock signal and a data signal are used for the description.

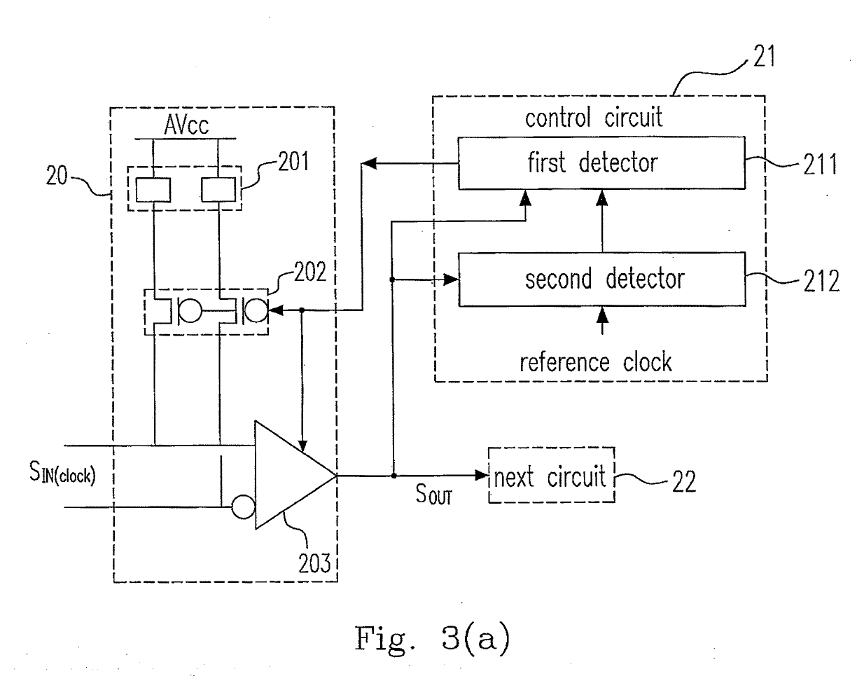

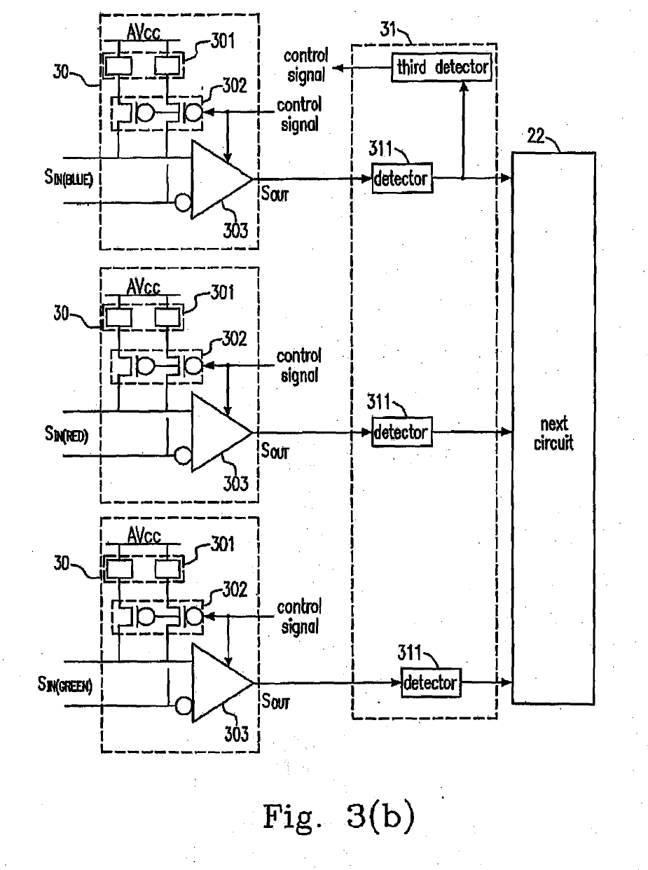

When the input signal S_{IN} is a clock signal, please refer to FIG. 3 (a), which is the block diagram showing an apparatus for power-saving and wake-up of a clock channel of the present invention. In this embodiment, the control circuit 21 also includes a first detector 211 and a second detector 212. The receiver 20 receives a clock signal S_{IN} (clock) from transmitter 11. Then, the clock signal S_{IN} (clock) is processing by the differential amplifier 203 and becomes an output signal S_{OUT}. The output signal S_{OUT} is respectively transmitted to three paths. One output signal S_{OUT} is transmitted to the next circuit 22 for the following treatment. Another output signal S_{OUT} is sent to a first detector 211 to detect a toggling of the output signal S_{OUT}. Another output signal S_{OUT} is sent to a second detector 212 to detect a frequency of the output signal S_{OUT} according to a reference clock. The control circuit 21 outputs a control signal (enable/disable signal), controlling the switch 23 open or close according to the detection result. Thus, there is no more power consumption in the clock channel (i.e. entering a power-saving mode). In another embodiment, only one of the toggling and frequency of the clock signal is detected, and output the detected signal according to the detection result. That is, the first detector 211 or the second detector 212 can be omitted.

When the input signal S_{IN} is a data signal, please refer to FIG. 3 (b), which is the block diagram showing an apparatus for power-saving and wake-up of a data channel of the present invention. In this embodiment, the control circuit 31 includes a decoder 311 and a third detector 312. The receiver 30 receives an encoded data signal S_{IN} (R/G/B) from transmitter 11. Then, the clock signal S_{IN} (R/G/B) is processing by the amplifier 303 and becomes an output signal S_{OUT} transmitted to the decoder 311. The decoded signal is sent to the third detector 312 to detect whether at least one of a horizontal synchronization signal (HS), a vertical synchronization signal (VS), or a data enable signal (DE) is normal, and thereby produces the detection result. The control circuit 31 outputs a control signal (enable or disable signal) to control the pair of switches 302 open or close according to the detection result. Therefore, the data channel no longer consumes the power (that is, entering a power-saving mode).

When the input signal S_{IN} includes a clock signal and a data signal, the receiver includes a clock channel receiver 20 and at least one data channel receiver 30. In an embodiment, the control circuit 21 of the clock channel receiver 20 respectively or simultaneously controls all the enablement (normal mode) or disablement (power-saving mode) of the channels. In Another embodiment, the control circuit 31 of the clock channel receiver 30 respectively or simultaneously controls all the enablement (normal mode) or disablement (power-saving mode) of the channels. In Another embodiment, the control circuit (21, 31) of each channel receiver (20, 30) respectively controls all the enablement (normal mode) or disablement (power-saving mode) of each channel.

Accordingly, the enabling and disabling actions of the above-mentioned clock enable signal and/or R/G/B data enable signal can be reached by one technique of the software control or hardware or both software and hardware by one skilled in the art.

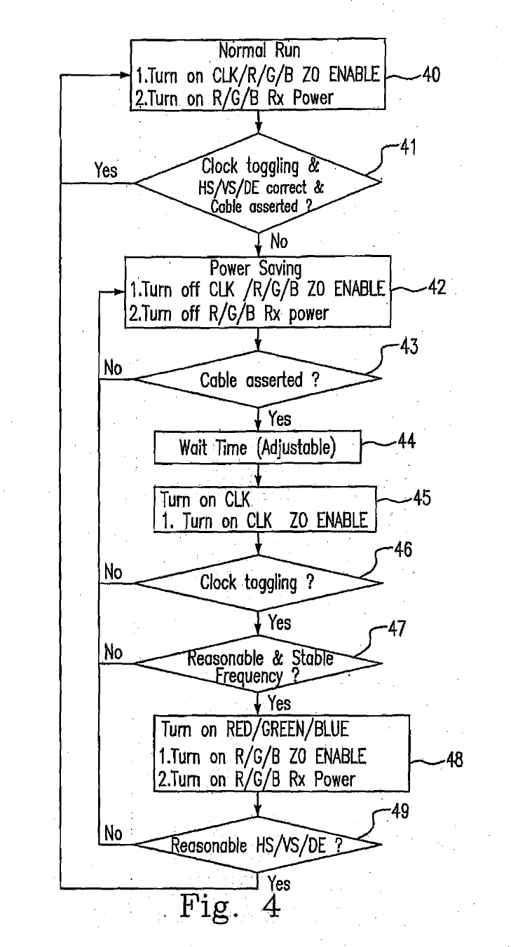

Please refer to FIG. 4, which is a flow chart the method for power-saving and wake-up in a signal receiving device according to an embodiment of the present invention. FIG. 4 is illustrated based on the fact that the input signal S_{IN} includes a clock signal and a data signal, and the description is also based on the examples that each of the channels is respectively controlled: first of all, when operating in a normal mode, the system turns on a clock enable signal and R/G/B enable signals and turns on R/G/B receiver power (step 40). Then, the system detects the steps: whether or not a toggling of the clock signal is abnormal, whether or not HS/VS/DE (horizontal sync, vertical sync and data enable) of plural data signals are abnormal, or whether the cable signal is abnormal (i.e. whether the cable 13 is connected to the receiver 20) (step 41). When the signals are all normal, the system maintains operating in the normal mode. When any one of signals is abnormal, the system turns off (OPEN) the pair of switches (202,302) and let each channel enter power-saving mode (step 42). At this moment, the power AVcc of each receiver (20 30) is unable to flow through the pair of resistors RT and RT′ and the transmission line 13 and be lead to the grounding of the transmitter 11. The receivers of each channel no longer consume any power (that is, entering into the power-saving mode).

Accordingly, in the operation of power-saving mode, after an adjustable period of time, the system detects whether the cable signal is normal (step 43). When the signal is abnormal, the system maintains operates in the power-saving mode. When the signal is normal, after an adjustable period of time (step 44), the system turns on the clock channel to receive and detect the clock signal (step 45).

Then, the system detects whether the toggling of the clock signal is normal (step 46). The system maintains operating in the power-saving mode when the signal is abnormal. When the toggling of the clock signal is normal, the system detects whether the frequency of the clock signal is normal (step 47).

Accordingly, the system maintains operating in the power-saving mode when the frequency of the clock signal is abnormal. The system turns on a blue channel and a blue data receiver power when the frequency of the clock signal is normal (step 48).

Then, the system detected whether the HS/VS/DE (horizontal sync, vertical sync and data enable) of blue channel are normal (step 49). When the signals are abnormal, the system maintains operating in the power-saving mode. When the signals are normal, the system enters into the operation in the normal mode (step 40).

There are several ways to wake up, for example: steps 44˜49 can be omitted (only determine whether the cable signal is normal), or steps 47˜49 can be omitted (only determine whether the cable signal and clock signal are normal), or steps 45˜47 can be omitted (only determine whether the cable signal and HS/VS/DE signals are normal). One skilled in the art can easily complete all kinds of deformations.

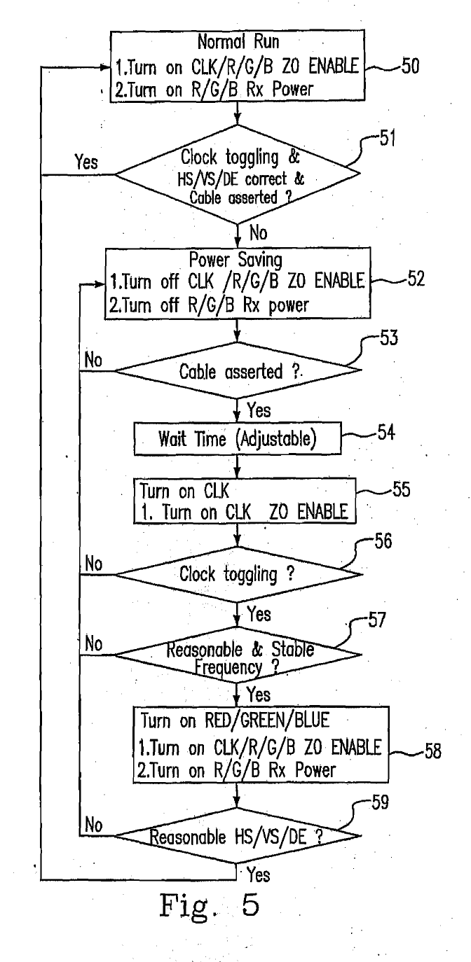

Please refer to FIG. 5, which illustrates a flow chart of the method for power-saving and wake-up in a signal receiving device according to an embodiment the present invention. First of all, when operating in a normal mode, the system turns on a clock enable signal and R/G/B enable signals and turns on R/G/B receiver power (step 50). Then, the system detects the steps: whether or not a cable signal, a clock signal, HS/VS/DE (horizontal sync, vertical sync and data enable) plural data signals are abnormal (step 51). When the signals are normal, the system maintains operating in the normal mode. When any one of the signals is abnormal, the system turns off a clock channel, R/G/B channel and enters power-saving mode (step 52).

after an adjustable period of time, the system detects whether the cable signal is normal (step 53). When the signal is abnormal, the system maintains operating in the power-saving mode. When the signal is normal, after an adjustable period of time (step 54), the detection function of the clock channel is enabled and the system turns on the clock channel (step 55).

Then, the system detects whether the toggling of clock signal is normal (step 56). The system maintains operating in the power-saving mode when the signal is abnormal. When the toggling of the clock signal is normal, the system detects whether frequency of the clock signal is normal (step 57).

Accordingly, the system maintains operating in the power-saving mode when the frequency of clock signal is abnormal. The system turns on the clock/R/G/B channels when the signal is normal (step 58).

Then, the system detects whether the HS/VS/DE (horizontal sync, vertical sync and data enable) of the R/G/B channels are normal 59. When the signals are abnormal, the system maintains operating in the power-saving mode. When the signals are normal, the system enters the operation in the normal mode (step 50).

To sum up, the present invention provides an apparatus and method for power-saving and wake-up. The signal receiving device system is working in the operation of normal mode. The system will turn off partial circuits' power and enter the operation in power-saving mode when the cable signal, the clock signal and data signal are abnormal. Thus, the present invention not only realizes the effect of power saving and reduce power but also monitors the receiver at any time. When the detected signal is normal, the system executes a wake up procedures and effectively turns on the receiver power to enter the normal mode.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method used in a power-saving mode of a receiver, comprising the steps of:
(a) detecting whether a first signal is normal in the power-saving mode and maintaining in the power-saving mode when the first signal is abnormal; and
(b) detecting whether a second signal is normal when the first signal is normal in the power-saving mode, and maintaining the receiver in the power-saving mode when the second signal is abnormal.

2. The method according to claim 1, wherein the receiver further comprises a first and a second channels and a power supply, and each of the steps (a) and (b) further comprises the steps of:
detecting at least one signal from one of the first and the second channels and producing a control signal according to a detected result; and
deciding whether to disconnect a connection between the power supply and at least one of the first and second channels according to the control signal so as to avoid a current flowing through the at least one of the first and second channels.

3. The method according to claim 1, wherein the steps (a) and (b) are respectively performed by a step (a1) of activating a detecting function of the first channel and a step (b1) of activating a detecting function of the second channel.

4. The method according to claim 1, wherein the receiver maintains in the power-saving mode when the first signal is abnormal.

5. The method according to claim 1, wherein the first and the second channels respectively transmit a clock signal and a data signal.

6. The method according to claim 1, wherein the first signal is one of a cable signal and a clock signal, and the second signal is one of the clock signal and a data signal.

7. The method according to claim 1, wherein the receiver operates in a normal mode if the second signal is normal.

8. The method according to claim 1, wherein the receiver has a third channel, and the method further comprises the steps of:
detecting whether a third signal from the third channel is normal in the power-saving mode when the second signal is normal, wherein the receiver maintains the power-saving mode when the third signal is abnormal; and
operating the receiver in the normal mode when the third signal is normal.

9. A receiver, comprising:
at least one of receiving units, coupled to at least one of channels, respectively, receiving an input signal from the at least one of the channels;
a control circuit detecting a specific one of the input signal from the at least one of the channels, producing a control signal according to a result of the detection, and having plural routes, each of which corresponds to the specific one of the input signal.

10. The receiver according to claim 9, wherein the receiver further comprises at least one chapel having the specific one of the input signal, a power supply, a receiver circuit receiving the specific one of the input signal from the at least one channel and having a control switch configured between the power supply and the at least one channel and deciding whether to disconnect a connection between the power supply and the at least one channel according to the control signal, and a following circuit receiving and processing an output signal from the receiver circuit.

11. The receiver according to claim 9, wherein the receiver further comprises at least one of a digital visual interface and a high definition multimedia interface.

12. The receiver according to claim 10, wherein the at least one channel has a first and a second channels respectively transmitting a clock signal and a data signal.

13. The receiver according to claim 11, wherein the data signal is any one of three pairs of red, green and blue data signals.

14. The receiver according to claim 9, wherein the at least one channel is used to transmit a clock signal, and the control circuit comprises a detector detecting at least one of toggling and frequency of the clock signal.

15. The receiver according to claim 10, wherein the at least one channel is used to transmit a data signal, and the control circuit comprises a decoder decoding a data signal from the at least one channel and a first detector detecting the decoded data signal.

16. A method for a receiver coupling to at least one channel and having a power supply, comprising the steps of:
detecting a specific one signal from the at least one channel and generating a control signal accordingly; and
deciding whether to disconnect a connection between the power supply and the at least one channel according to the control signal so as to avoid a current flowing through the at least one channel when the receiver operates in a power-saving mode.

17. A method according to claim 16, wherein the at least one channel comprises a first channel and a second channel having plural decoded data signals, and the method further comprises:
detecting at least one of toggling and frequency of the clock signal of the first channel;
detecting a specific one of the plural decoded data signals; and
wherein the receiver turns off the first and the second channels when the detected specific decoded data signal is abnormal, and operates in a power-saving node.

18. The method according to claim 17, wherein the plural decoded data signals comprise a horizontal synchronization signal, a vertical synchronization signal and a data enable signal.

19. The method according to claim 16, wherein the at least one channel comprises a first and a second channels, the receiver further comprises a control switch deciding whether to disconnect a connection between the power supply and at least one of the first channel and the second channel according to the control signal, and the first channel and the second channel respectively transmit a clock signal and a data signal.
